(19) United States
(12) Patent Application Publication
(10) Pub. No.: US 2025/0314298 A1
(43) Pub. Date: Oct. 9, 2025

(54) METHODS OF MANUFACTURING COMPOSITE SEALS, COMPOSITE SEALS, AND ASSEMBLIES WITH COMPOSITE SEALS

(71) Applicant: The Boeing Company, Arlington, VA (US)

(72) Inventors: Tiffany A. Stewart, Los Angeles, CA (US); Bradley W. Kibbel, Everett, WA (US); Shah Rifat Alam Bhuiyan, Mountlake Terrace, WA (US); Jessica M. Ribble, Ridgeville, SC (US); Vanda L. Ngo, Huntington Beach, CA (US); Kevin R. Lenihan, Garden Grove, CA (US); Thomas A. Dean, Maple Valley, WA (US); Catherine A. Baker, Mukilteo, WA (US)

(21) Appl. No.: 18/628,512

(22) Filed: Apr. 5, 2024

(51) Int. Cl. F16J 15/14; F01D 11/00

(52) U.S. Cl. CPC F16J 15/14; F01D 11/00; F05D 2240/55

(57) ABSTRACT

Methods of manufacturing composite seals comprise applying a fluid barrier material to a fire barrier textile that is constructed of one or more materials, and forming the fire barrier textile into a profile. Composite seals comprise a fluid barrier material applied to a fire barrier textile. Assemblies comprise a first structure, a second structure, and a composite seal operatively engaged between the first structure and the second structure.

### FIELD

The present disclosure relates to composite seals.

### BACKGROUND

Fire, fluid, and pressure seals are used in various locations in aircraft construction, such as in nacelle assembles. Existing seal technologies have limited lifespans and are not easily customized for particular applications.

### SUMMARY

Methods of manufacturing composite seals, composite seals, and assemblies comprising composite seals are disclosed herein. Methods of manufacturing composite seals comprise applying a fluid barrier material to a fire barrier textile that is constructed of one or more materials, and forming the fire barrier textile into a profile. Composite seals comprise a fire barrier textile and a fluid barrier material applied to the fire barrier textile. Assemblies comprise a first structure, a second structure, and a composite seal operatively engaged between the first structure and the second structure.

### BRIEF DESCRIPTION OF THE DRAWINGS

FIG. 1 illustrates an example aircraft.

FIG. 2 is a flowchart schematically representing methods according to the present disclosure.

FIG. 3 is an illustration schematically representing composite seals according to the present disclosure.

FIG. 4 is another illustration schematically representing composite seals according to the present disclosure.

FIG. 5 illustrates examples of profiles of composite seals according to the present disclosure.

FIG. 6 is a plan view of an example fire barrier textile according to the present disclosure.

FIG. 7 is a plan view of another example fire barrier textile according to the present disclosure.

FIG. 8 is a plan view of another example fire barrier textile according to the present disclosure.

FIG. 9 is an illustration schematically representing assemblies according to the present disclosure.

### DESCRIPTION

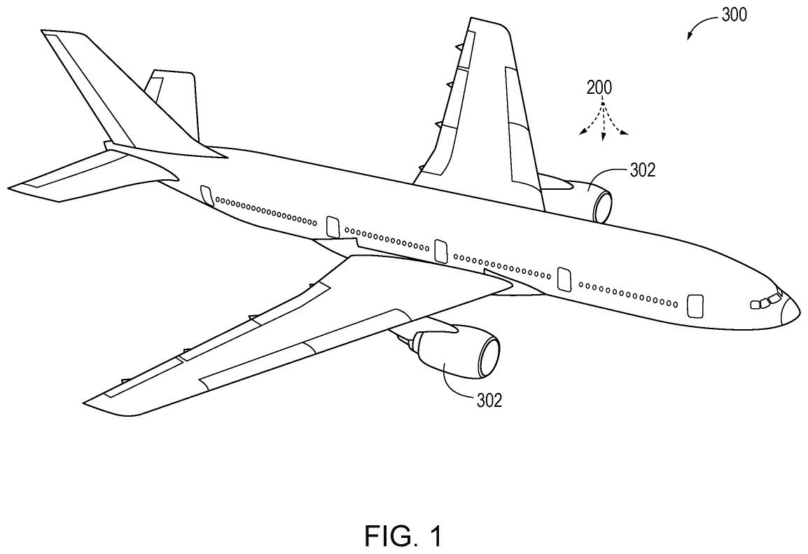

Methods 100 of manufacturing composite seals 10, composite seals 10, and assemblies 200 with one or more composite seals 10 are disclosed herein. Composite seals 10 are seals that are constructed from more than one material and generally provide more than one function, such as providing two or more of a fluid barrier, a pressure barrier, and a fire barrier between two adjacent structures. That is, some composite seals 10 according to the present disclosure are configured to be used in applications where it is desirable to restrict passage of fluids and where it is desirable to restrict passage of fire. In particular, such composite seals 10 may find benefit in the aerospace industry, although composite seals 10 are not limited to being used in the aerospace industry. As an illustrative, non-exclusive example with reference to FIG. 1, an aircraft 300 may comprise one or more assemblies 200 with one or more composite seals 10. For example, nacelle assemblies 302 of an aircraft 300 may comprise one or more composite seals 10. Composite seals 10 also may be utilized in connection with fire barriers and fire walls in locations other than nacelle assemblies 302.

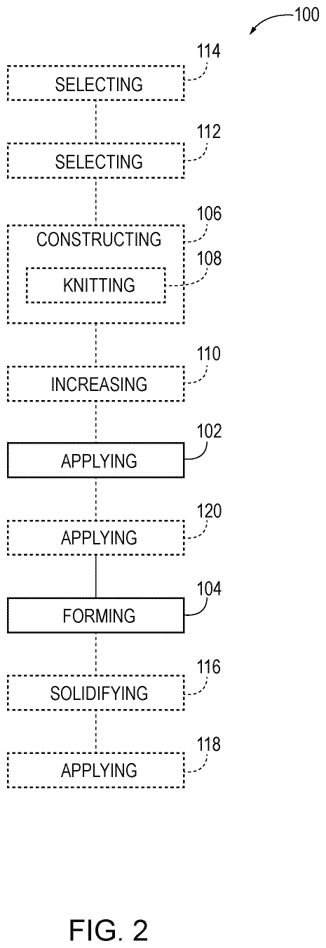

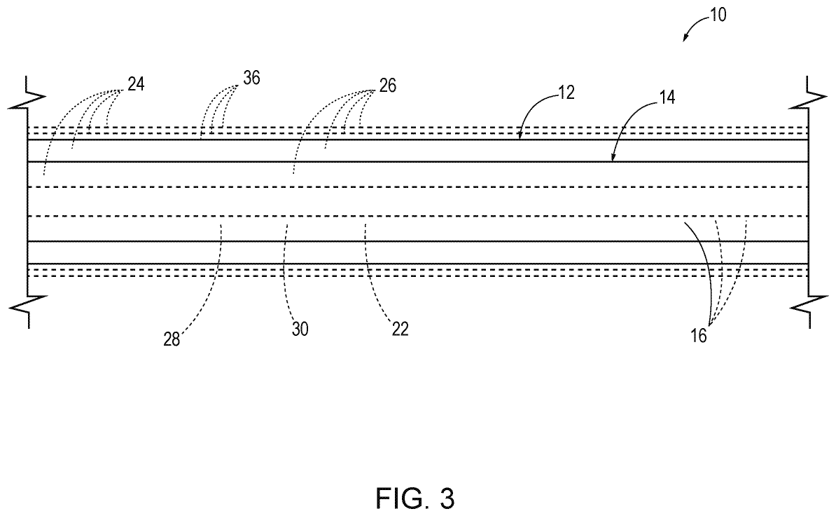

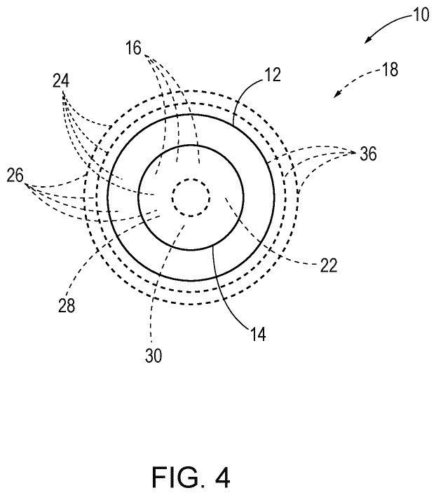

FIG. 2 schematically provides a flowchart that represents illustrative, non-exclusive examples of methods 100 according to the present disclosure, and FIGS. 3 and 4 schematically represent composite seals 10 according to the present disclosure. Generally, in these figures, elements that are likely to be included in a given example are illustrated in solid lines, while elements that are optional to a given example or that correspond to a specific example are illustrated in broken lines. However, elements that are illustrated in solid lines are not essential to all examples of the present disclosure, and an element shown in solid lines may be omitted from a particular example without departing from the scope of the present disclosure. Moreover, in connection with FIG. 2, unless otherwise set forth herein, the steps of methods 100 are not required to be performed in the order depicted. In addition, the methods and steps illustrated in FIG. 2 are not limiting and other methods and steps are within the scope of the present disclosure, including methods having greater than or fewer than the number of steps illustrated, as understood from the discussions herein. While the following discussion generally refers to composite seals 10 in the context of being constructed according to methods 100, methods 100 are not limiting, and composite seals 10 according to the present disclosure may be constructed utilizing any suitable method that results in the disclosed composite seals 10.

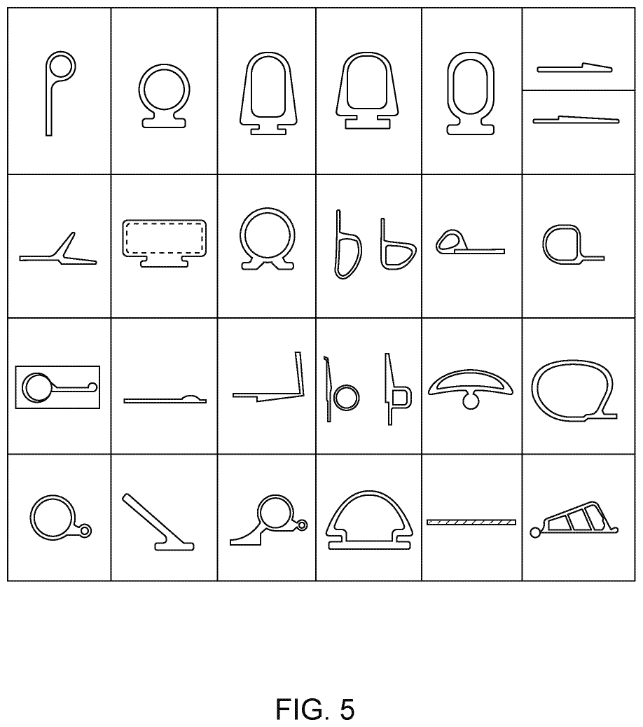

With reference to FIGS. 2-4, methods 100 of manufacturing composite seals 10 comprise applying 102 a fluid barrier material 12 to a fire barrier textile 14 that is constructed of one or more materials 16, and forming 104 the fire barrier textile 14 into a profile 18 (e.g., a desired or predetermined profile). FIG. 3 schematically represents a side cross-sectional view of composite seals 10, while FIG. 4 schematically represents an end cross-sectional view of composite seals 10. While FIG. 4 schematically illustrates a circular profile 18, such presentation is not limiting, and composite seals 10 may be constructed with any profile 18. FIG. 5 illustrates several illustrative-non-exclusive examples of profiles 18 with which composite seals 10 may be constructed. Generally, a profile 18 is selected based on a specific application for the composite seal 10 and the relevant structures between which the composite seal 10 is intended to be installed for operative use. As represented in FIG. 5, in some examples, the composite seal 10 is hollow, that is, with an internal void. In other examples, the composite seal 10 is not hollow.

The fire barrier textile 14 may be described as a fire-resistant or fire-proof substrate, to which the fluid barrier material 12 is applied. In some examples, the fluid barrier material 12 penetrates the fire barrier textile 14. In other words, in such examples, the fluid barrier material 12 extends between the filaments, or fibers, of the fire barrier textile 14. In some such examples, the fluid barrier material 12 penetrates fully through the fire barrier textile 14 covering both an outer surface and an inner surface of the fire barrier textile 14. In other examples, the fluid barrier material 12 covers only one side of the fire barrier textile 14. In some examples, the fluid barrier material 12 fully defines an outer surface 36 of the composite seal 10.

In some examples of methods 100, the applying 102 is performed prior to the forming 104, and the forming 104 comprises forming the fire barrier textile 14 and the fluid barrier material 12 into the profile 18. In other words, in some examples, the fire barrier textile 14 and the fluid barrier material 12 are formed together into the profile 18. In other examples, the forming 104 is performed prior to the applying 102. That is, in such examples, the fire barrier textile 14 is first formed into the profile 18 and then the fluid barrier material 12 is applied to the fire barrier textile 14 already in the profile 18.

As schematically represented in FIG. 2, some methods 100 further comprise, prior to the applying 102 and the forming 104, constructing 106 the fire barrier textile 14 from the one or more materials 16. In other words, the same entity may construct the fire barrier textile 14 and apply the fluid barrier material 12 thereto. However, in other examples, an entity may acquire the fire barrier textile 14 from a third party already in its textile form, and then apply the fluid barrier material 12 thereto. That is, the entity that applies the fluid barrier material 12 is not required to be the same entity that constructs the fire barrier textile 14.

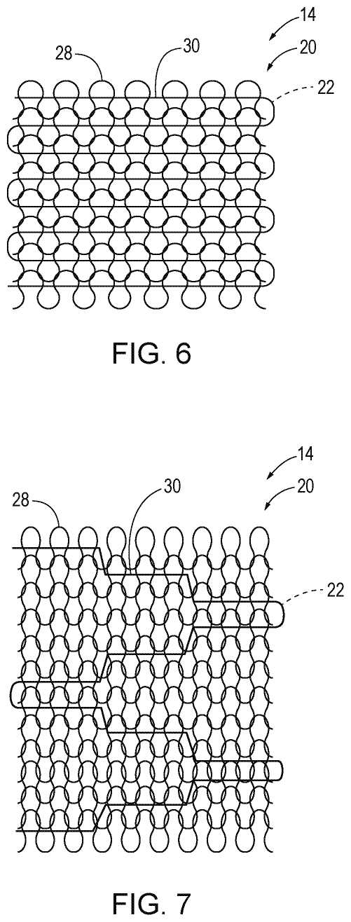

In some examples, the fire barrier textile 14 is an at least partially knitted textile. That is, at least part of the fire barrier textile 14 may be constructed utilizing a knitting process. Accordingly, as schematically represented in FIG. 2, in some methods 100, the constructing 106 comprises knitting 108 the fire barrier textile 14 from at least a first subset 28 of the one or more materials 16. As an example, the knitting 108 may comprise flat knitting. FIGS. 6-8 illustrate examples of fire barrier textiles 14 that are partially knitted.

In some examples, the knitting 108 comprises knitting the first subset 28 around at least a second subset 30 of the one or more materials 16. In other words, the first subset 28 of materials may be knitted, and the second subset 30 of materials may be described as being inlaid within the knit of the first subset 28. Each subset of materials may comprise one or more materials, and each subset of materials may be selected for specific desired properties of a particular composite seal 10.

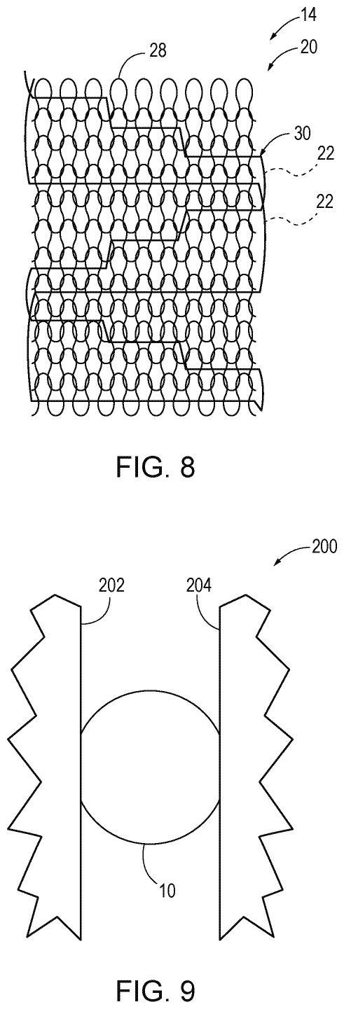

In some examples, during the knitting 108, the second subset 30 may be positioned in a predetermined pattern 20. FIGS. 6-8 illustrate three non-exclusive examples of predetermined patterns 20. In FIG. 6, the second subset 30 is arranged in a uniform and parallel undulating pattern back and forth across the first subset 28. The example of FIG. 7 may be described as having the subset 30 arranged in a stair-stepped undulating pattern back and forth across the first subset 28. FIG. 8 illustrates an example, in which the subset 30 comprises two distinct filaments, one arranged in a uniform and parallel undulating pattern and one arranged in a stair-stepped undulating pattern. The examples of FIGS. 6-8 are non-limiting and other patterns also may be used with methods 100 and composite seals 10.

In some examples, the predetermined pattern 20 is configured and/or selected to define a composite-seal spring rate (e.g., a desired or predetermined spring-rate) of the composite seal 10. Herein, when discussing the spring rate of a composite seal 10 or sub-element thereof, it is referring to the stiffness of the composite seal 10 or sub-element thereof across the profile 18 thereof. It is this spring rate, or stiffness, that determines the effectiveness of the composite seal 10 in a particular application, such as between two adjacent structures. In some examples, the first subset 28 on its own may have a first spring rate that is insufficient to meet the desired sealing properties of a composite seal 10. Accordingly, the second subset 30 may be incorporated into the composite seal 10 to result in an overall composite-seal spring rate that is sufficient for a desired application. That is, in some examples, the second subset 30 has a second spring rate that is greater than a first spring rate of the first subset 28.

In some examples, the second subset 30 comprises one or more metallic wires 22.

In some examples, the one or more materials 16 of the fire barrier textile 14 are selected for desired thermal properties of the composite seals 10. As an example, the one or more materials 16 of the fire barrier textile 14 may be more thermally stable than the fluid barrier material 12. For example, over time, conventional fabric reinforced rubber seals experience compression set after prolonged and elevated temperature exposure. The inclusion of a more thermally stable material 16 in a composite seal 10 may prevent or delay this issue and prolong the usable lifespan of the composite seal 10 over an otherwise similarly constructed composite seal without such thermally stable materials included therein.

As schematically represented in FIG. 2, some methods 100 further comprise, following the forming 104, increasing 110 the second spring rate, the hardness, or the strength of the second subset 30. Additionally or alternatively, the increasing 110 may comprise curing the second subset 30, such as when the second subset 30 comprises a curable material. The increasing 110 therefore may be performed to customize or otherwise select desired physical properties of a composite seal 10.

Not only may the materials of the first subset 28 and the second subset 30 differ, but also their relative size may differ. For example, the first subset 28 may have an average first-subset diameter, the second subset 30 may have an average second-subset diameter that is greater than the average first-subset diameter. Alternatively, the average second-subset diameter may be less than average first-subset diameter, or the average first-subset diameter and the average second-subset diameter may have the same size, depending on the material properties of the first subset and the second subset and the desired final properties of the composite seal 10.

In some examples of methods 100, the knitting 108 comprises varying a density of the fire barrier textile 14 along a length of the fire barrier textile 14. Correspondingly, in some examples of composite seals 10, the density of the fire barrier textile 14 varies along a length of the fire barrier textile 14. For example, the varying may be based on predetermined sealing requirements for the composite seal 10 in a specific use-case. Such a configuration may be desired when different sealing characteristics are needed or otherwise desired at different locations along a composite seal 10. For example, when a composite seal 10 curves around a tight bend, a lower density of fire barrier textile 14 may be appropriate due to the compression of the composite seal 10 in the tight bend. Additionally or alternatively, some sections of lengths of a composite seal 10 may need to have greater fire resistance than other seconds of lengths of the composite seal 10 depending on the structure adjacent to those sections and/or depending on the likelihood and/or intensity of a possible fire along those sections. Different densities of the fire barrier textile 14 may be accomplished by the knitting process, such as by knitting the first subset 28 of material in tighter or looser knits, by utilizing different knitting techniques and/or patterns, and/or by utilizing different diameters/thicknesses of material. Similarly, when a second subset 30 of material is included, it need not be present along an entire length of a composite seal 10 and instead may be present in only one or more select sections of length of a composite seal where desired and/or needed.

As schematically represented in FIG. 2, some methods 100 further comprise prior to the constructing 106, selecting 112 the one or more materials 16 based on a specific use-case for the composite seal 10. As illustrative, non-exclusive examples, the selecting 112 may be based on one or more of service temperature range, fluid resistance, fluid barrier capability, pressure barrier capability, thermal insulation capability, repairability, durability in temperature environment, durability in vibration environment, flexibility, temperature tolerance, strength, durability, corrosion resistance, weight, and/or fire resistance of the composite seal 10 being constructed.

Illustrative, non-exclusive examples of materials 16 include one or more of ceramic, S-glass, E-glass, glass fiber, ceramic fiber, carbon fiber, and/or boron fiber.

Similarly, as schematically represented in FIG. 2, some methods 100 further comprise, prior to the applying 102, selecting 114 the fluid barrier material 12 based on a specific use-case for the composite seal 10. As illustrative, non-exclusive examples, the selecting 114 may be based on one or more of service temperature range, fluid resistance, fluid barrier capability, pressure barrier capability, thermal insulation capability, repairability, durability in temperature environment, durability in vibration environment, fungus growth resistance, chemical resistance, stiffness, flexibility, temperature tolerance, strength, durability, weight, and/or fire resistance.

Illustrative, non-exclusive examples of fluid barrier materials 12 include one or more polymers and/or elastomers. As more specific examples, fluid barrier materials 12 may comprise one or more of silicone, fluorosilicone, fluorocarbon elastomer, perfluoronated elastomer, and/or polyvinyl fluoride. The applying 102 of the fluid barrier material 12 to the fire barrier textile may be accomplished in various ways. For example, the applying 102 may comprise one or more of calendaring the fluid barrier material 12 to the fire barrier textile 14, penetrating the fire barrier textile 14 with the fluid barrier material 12, spraying the fluid barrier material 12 on the fire barrier textile 14, doctor-blading, coating, skim coating, wrapping, and/or laminating the fire barrier textile 14 with the fluid barrier material 12, and/or dipping the fire barrier textile 14 in the fluid barrier material 12. The technique for applying 102 may be selected based on a desired penetration of the fire barrier textile 14 with the fluid barrier material 12 or otherwise on the desired properties of the composite seal 10 being constructed.

With continued reference to FIG. 2, some methods 100 further comprise, following the applying 102, solidifying 116 the fluid barrier material 12. For example, the fluid barrier material 12 may be a curable material. Accordingly, the applying 102 may be performed while the fluid barrier material 12, or its component parts, is in a liquid phase and subsequently may be solidified following the applying 102 when the fluid barrier material 12 is operatively applied to and/or around the fire barrier textile 14.

With reference to FIG. 2, some methods 100 further comprise applying 118 insulation 24, and with reference to FIGS. 3 and 4, some composite seals 10 comprise insulation 24. In some examples, as schematically represented in FIGS. 3 and 4, the insulation 24 may be applied as its own layer in the composite seal 10. Additionally or alternatively, as also schematically represented in FIGS. 3 and 4, the insulation 24 may be a component of the fluid barrier material 12, or the fire barrier textile 14. In some examples, the insulation 24 defines the outer surface 36 of the composite seal 10. In other examples, the insulation 24 defines an inner surface of the composite seal 10.

As examples, the insulation 24, when present, may comprise one or more of felt, matt, packed powder, gel (such as sol-gel), paper, batting, foam, or sponge made from fiberglass, ceramic (including both oxide and non-oxide ceramics), polyimide, and/or elastomers.

Similarly, with reference to FIG. 2, some methods 100 further comprise applying 120 a wear material 26, and with reference to FIGS. 3 and 4, some composite seals 10 comprise a wear material 26. In some examples, as schematically represented in FIGS. 3 and 4, the wear material 26 may be applied as its own layer in the composite seal 10. Additionally or alternatively, as also schematically represented in FIGS. 3 and 4, the wear material may be a component of the fluid barrier material 12, or the fire barrier textile 14. In some examples, the wear material 26 defines an outer surface 36 of the composite seal 10.

As examples, the wear material 26, when present, may comprise one or more of aramid, polyaramid (e.g., sold under the NOMEX™ or KEVLAR™ brands), polyimide (e.g., sold under the VESPEL™ brand), polyamide (e.g., nylon), polyester, reinforced fluoropolymers (e.g., sold under the RULON™ brand), reinforced perfluoroether, reinforced silicone, and/or reinforced fluorosilicone.

Turning now to FIG. 9, also within the scope of the present disclosure are assemblies 200 that comprise a first structure 202, a second structure 204, and a composite seal 10 operatively engaged between the first structure 202 and the second structure 204. As an example, the assembly 200 may be an aircraft assembly, and the first structure 202 and the second structure 204 may comprise a nacelle assembly 302 of an aircraft 300.

Illustrative, non-exclusive examples of inventive subject matter according to the present disclosure are described in the following enumerated paragraphs:

A. A method (100) of manufacturing a composite seal (10), the method (100) comprising:
applying (102) a fluid barrier material (12) to a fire barrier textile (14) that is constructed of one or more materials (16); and
forming (104) the fire barrier textile (14) into a profile (18).

A1. The method (100) of paragraph A, wherein the fire barrier textile (14) is an at least partially knitted textile.

A2. The method (100) of any of paragraphs A-A1, wherein the applying (102) is performed prior to the forming (104), and wherein the forming (104) comprises forming the fire barrier textile (14) and the fluid barrier material (12) into the profile (18).

A3. The method (100) of any of paragraphs A-A1, wherein the forming (104) is performed prior to the applying (102).

A4. The method (100) of any of paragraphs A-A3, further comprising, prior to the applying (102) and the forming (104), constructing (106) the fire barrier textile (14) from the one or more materials (16).

A4.1. The method (100) of paragraph A4, wherein the constructing (106) comprises knitting (108) the fire barrier textile (14) from at least a first subset (28) of the one or more materials (16).

A4.1.1. The method (100) of paragraph A4.1, wherein the knitting (108) comprises flat knitting.

A4.1.1.1. The method (100) of any of paragraphs A4.1-A4.1.1, wherein the knitting (108) comprises knitting the first subset (28) around at least a second subset (30) of the one or more materials (16).

A4.1.1.1.1. The method (100) of paragraph A4.1.1.1, wherein during the knitting (108), the second subset (30) is positioned in a predetermined pattern (20).

A4.1.1.1.1.1. The method (100) of paragraph A4.1.1.1.1., wherein the predetermined pattern (20) is configured to define a composite-seal spring rate of the composite seal (10).

A4.1.1.1.2. The method (100) of any of paragraphs A4.1.1.1-A4.1.1.1.1.1, wherein the second subset (30) has a second spring rate that is greater than a first spring rate of the first subset (28).

A4.1.1.1.3. The method (100) of any of paragraphs A4.1.1.1-A4.1.1.1.2, wherein the second subset (30) comprises a metallic wire (22).

A4.1.1.1.4. The method (100) of any of paragraphs A4.1.1.1-A4.1.1.1.3, further comprising, following the forming (104), increasing (110) a/the second spring rate, a hardness, and/or a strength of the second subset (30).

A4.1.1.1.5. The method (100) of any of paragraphs A4.1.1.1-A4.1.1.1.4, wherein the first subset (28) has an average first-subset diameter, and wherein the second subset (30) has an average second-subset diameter that is greater than the average first-subset diameter (32).

A4.2. The method (100) of any of paragraphs A4-A4.1.1.1.5, wherein the constructing (106) comprises varying a density of the fire barrier textile (14) along a length of the fire barrier textile (14).

A4.2.1. The method (100) of paragraph A4.2, wherein the varying is based on predetermined sealing requirements for the composite seal (10) in a specific use-case.

A4.3. The method (100) of any of paragraphs A4-A4.2.1, further comprising, prior to the constructing (106), selecting (112) the one or more materials (16) based on a/the specific use-case for the composite seal (10).

A4.3.1. The method (100) of paragraph A4.3, wherein the selecting (112) the one or more materials (16) comprises selecting the one or more materials (16) based on one or more of service temperature range, fluid resistance, fluid barrier capability, pressure barrier capability, thermal insulation capability, repairability, durability in temperature environment, durability in vibration environment, flexibility, temperature tolerance, strength, durability, corrosion resistance, weight, and/or fire resistance.

A5. The method (100) of any of paragraphs A-A4.2.1, wherein the one or more materials (16) comprise one or more of ceramic, S-glass, E-glass, glass fiber, ceramic fiber, carbon fiber, and/or boron fiber.

A6. The method (100) of any of paragraph A-A5, wherein the fluid barrier material (12) comprises one or more polymers and/or elastomers.

A7. The method (100) of any of paragraphs A-A6, further comprising, prior to the applying (102), selecting (114) the fluid barrier material (12) based on a/the specific use-case for the composite seal (10).

A7.1. The method (100) of paragraph A7, wherein the selecting (114) comprises selecting the fluid barrier material (12) based on one or more of service temperature range, fluid resistance, fluid barrier capability, pressure barrier capability, thermal insulation capability, repairability, durability in temperature environment, durability in vibration environment, fungus growth resistance, chemical resistance, stiffness, flexibility, temperature tolerance, strength, durability, weight, and/or fire resistance.

A8. The method (100) of any of paragraphs A-A7.1, wherein the applying (102) comprises calendaring the fluid barrier material (12) to the fire barrier textile (14).

A9. The method (100) of any of paragraphs A-A8, wherein the applying (102) comprises penetrating the fire barrier textile (14) with the fluid barrier material (12).

A10. The method (100) of any of paragraphs A-A9, wherein the applying (102) comprises spraying the fluid barrier material (12) on the fire barrier textile (14).

A11. The method (100) of any of paragraphs A-A10, wherein the applying (102) comprises doctor-blading.

A12. The method (100) of any of paragraphs A-A11, wherein the applying (102) comprises one or more of coating, skim coating, wrapping, and/or laminating the fire barrier textile (14) with the fluid barrier material (12).

A13. The method (100) of any of paragraphs A-A12, wherein the applying (102) comprises dipping the fire barrier textile (14) in the fluid barrier material (12).

A14. The method (100) of any of paragraphs A-A13, further comprising, following the applying (102), solidifying (116) the fluid barrier material (12).

A15. The method (100) of any of paragraphs A-A14, further comprising applying (118) insulation (24).

A15.1. The method (100) of paragraph A15, wherein the insulation (24) comprises one or more of felt, matt, packed powder, gel (such as sol-gel), paper, batting, foam, or sponge made from fiberglass, ceramic (including both oxide and non-oxide ceramics), polyimide, and/or elastomers.

A16. The method (100) of any of paragraphs A-A15.1, further applying (120) a wear material (26).

A16.1. The method (100) of paragraph A16, wherein the wear material (26) comprises aramid, polyaramid, polyimide, polyamide, polyester, reinforced fluoropolymers, reinforced perfluoroether, reinforced silicone, and/or reinforced fluorosilicone.

A17. The method (100) of any of paragraphs A-A16.1, wherein the composite seal (10) is the composite seal (10) of any of paragraphs B-B10.

B. A composite seal (10), comprising:
a fire barrier textile (14); and
a fluid barrier material (12) applied to the fire barrier textile (14).

B1. The composite seal (10) of paragraph B, wherein the fire barrier textile (14) is an at least partially knitted textile.

B1.1. The composite seal (10) of paragraph B1, wherein the fire barrier textile (14) is an at least partially flat-knitted textile.

B2. The composite seal (10) of any of paragraphs B-B1.1, wherein the fire barrier textile (14) comprises one or more materials (16).

B2.1. The composite seal (10) of paragraph B2, wherein the one or more materials (16) comprises a first subset (28) and a second subset (30) that is different from the first subset (28).

B2.1.1. The composite seal (10) of paragraph B2.1, wherein the first subset (28) is knitted around the second subset (30).

B2.1.2. The composite seal (10) of any of paragraphs B2.1-B2.1.1, wherein the second subset (30) has a spring rate that is greater than the first subset (28).

B2.1.3. The composite seal (10) of any of paragraphs B2.1-B2.1.2, wherein the second subset (30) has a higher thermal stability than the first subset (28) and/or wherein the second subset (30) has a higher thermal stability than the fluid barrier material (12).

B2.1.4. The composite seal (10) of any of paragraphs B2.1-B2.1.3, wherein the second subset (30) comprises a metallic wire (22).

B2.1.5. The composite seal (10) of any of paragraphs B2.1-B2.1.4, wherein the first subset (28) has an average first-subset diameter, and wherein the second subset (30) has an average second-subset diameter that is greater than the average first-subset diameter.

B2.2. The composite seal (10) of any of paragraphs B2-B2.1.5, wherein the one or more materials (16) comprises one or more of ceramic, S-glass, E-glass, glass fiber, ceramic fiber, carbon fiber, and/or boron fiber.

B3. The composite seal (10) of any of paragraphs B-B2.2, wherein the fluid barrier material (12) comprises one or more polymers and/or elastomers.

B4. The composite seal (10) of any of paragraphs B-B3, wherein a density of the fire barrier textile (14) varies along a length of the composite seal (10).

B5. The composite seal (10) of any of paragraphs B-B4, wherein the fluid barrier material (12) penetrates the fire barrier textile (14).

B6. The composite seal (10) of any of paragraphs B-B5, wherein the fluid barrier material (12) covers the fire barrier textile (14).

B7. The composite seal (10) of any of paragraphs B-B6, wherein the fluid barrier material (12) fully defines an outer surface (36) of the composite seal (10).

B8. The composite seal (10) of any of paragraphs B-B7, further comprising insulation (24).

B8.1. The composite seal (10) of paragraph B8, wherein the insulation (24) defines an/the outer surface (36) of the composite seal (10).

B8.2. The composite seal (10) of any of paragraphs B8-B8.1, wherein the insulation (24) comprises one or more of felt, matt, packed powder, gel (such as sol-gel), paper, foam, or sponge made from fiberglass, ceramic (including both oxide and non-oxide ceramics), polyimide, elastomers, and/or batting.

B9. The composite seal (10) of any of paragraphs B-B8.2, further comprising a wear material (26).

B9.1. The composite seal (10) of paragraph B9, wherein the wear material (26) defines an/the outer surface (36) of the composite seal (10).

B9.2. The composite seal (10) of any of paragraphs B9-B9.1, wherein the wear material (26) comprises aramid fibers.

B10. The composite seal (10) of any of paragraphs B-B9.2, wherein the composite seal (10) is hollow.

C. An assembly (200), comprising:
a first structure (202);
a second structure (204); and
the composite seal (10) of any of paragraphs B-B10 operatively engaged between the first structure (202) and the second structure (204).

C1. The assembly (200) of paragraph C, wherein the assembly (200) is an aircraft assembly (300).

C1.1. The assembly (200) of paragraph C1, wherein the first structure (202) and the second structure (204) comprise a nacelle assembly (302).

D. Use of the composite seal (10) of any of paragraphs B-B10 to provide a fluid, pressure, and fire barrier between two structures.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A method of manufacturing a composite seal, the method comprising:
applying a fluid barrier material to a fire barrier textile that is constructed of one or more materials; and
forming the fire barrier textile into a profile.

2. The method of claim 1, wherein the fire barrier textile is an at least partially knitted textile.

3. The method of claim 1, wherein the applying is performed prior to the forming, and wherein the forming comprises forming the fire barrier textile and the fluid barrier material into the profile.

4. The method of claim 1, wherein the forming is performed prior to the applying.

5. The method of claim 1, further comprising, prior to the applying and the forming, constructing the fire barrier textile from the one or more materials.

6. The method of claim 5, wherein the constructing comprises knitting the fire barrier textile from at least a first subset of the one or more materials.

7. The method of claim 6, wherein the knitting comprises flat knitting.

8. The method of claim 6, wherein the knitting comprises knitting the first subset around at least a second subset of the one or more materials.

9. The method of claim 8, wherein during the knitting, the second subset is positioned in a predetermined pattern.

10. The method of claim 9, wherein the predetermined pattern is configured to define a composite-seal spring rate of the composite seal.

11. The method of claim 8, wherein the second subset has a second spring rate that is greater than a first spring rate of the first subset.

12. The method of claim 8, wherein the second subset comprises a metallic wire.

13. The method of claim 8, further comprising, following the forming, increasing a second spring rate, a hardness, and/or a strength of the second subset.

14. The method of claim 8, wherein the first subset has an average first-subset diameter, and wherein the second subset has an average second-subset diameter that is greater than the average first-subset diameter.

15. The method of claim 5, wherein the constructing comprises varying a density of the fire barrier textile along a length of the fire barrier textile.

16. The method of claim 1, further comprising, following the applying, solidifying the fluid barrier material.

17. A composite seal, comprising:
a fire barrier textile; and
a fluid barrier material applied to the fire barrier textile.

18. The composite seal of claim 17, wherein the fire barrier textile is an at least partially knitted textile.

19. An assembly, comprising:
a first structure;
a second structure; and
the composite seal of claim 18 operatively engaged between the first structure and the second structure.

20. The assembly of claim 19, wherein a density of the fire barrier textile varies along a length of the composite seal.
